(19) United States
(12) Patent Application Publication
(10) Pub. No.: US 2023/0164652 A1
(43) Pub. Date: May 25, 2023

(54) RE-SELECTION OF A PGW-C/SMF IN THE DESIRED NETWORK SLICE

(71) Applicant: Telefonaktiebolaget LM Ericsson (publ), Stockholm (SE)

(72) Inventors: Yong Yang, Kållered (SE); Tony Olsson, Nösund (SE)

(21) Appl. No.: 17/798,671

(22) PCT Filed: Feb. 11, 2021
(86) PCT No.: PCT/EP2021/053283

§ 371 Date: Aug. 10, 2022

Related U.S. Application Data
(60) Provisional application No. 62/976,157, filed on Feb. 13, 2020.

(51) Int. Cl. H04W 36/12; H04W 36/00

(52) U.S. Cl. CPC H04W 36/12; H04W 36/0055

(57) ABSTRACT

Disclosed herein is a method performed by a first network node (e.g., SMF/PGW-C #1) for interworking between a 4G Evolved Packet Network (EPC) and a 5G core (5GC). The method comprises: receiving, at a first network node, a request to create a session for a User Equipment (UE) for a particular Access Point Name/Data Network Name (APN/DNN); determining that the first network node is not configured to support a subscribed network slice of the UE that contains the particular APN/DNN; identifying a second network node (e.g., PGW2 or second SMF/PGW-C) that is configured to support the subscribed network slice of the UE that contains the particular APN/DNN; and transferring, to the second network node, the request to create a session for the UE for the particular APN/DNN.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Interworking between the Evolved Packet Core (EPC) of 4G and the 5G Core (5GC) requires the selection of a Session Management Function (SMF)/Packet Data Network Gateway-Control Plane (PGW-C) (which may be implemented as a combined SMF/PGW-C network function) together with a User Plane Function (UPF)/Packet Data Network Gateway-User Plane (PGW-U) (which may be implemented as a combined UPF/PGW-U network function). This is vital to maintain session continuity when the User Equipment (UE) moves between a 4G radio access network and a 5G radio access network (see, e.g., 3^{rd} Generation Partnership Project (3GPP) Technical Specification (TS) 23.501 ch. 5.17.2; TS 23.502 ch. 4.11; TS 29.303 ch.

5.12.3).

### FIG. 1

A UE may attempt to access services available over a 5GC radio access via 5G radio access (i.e., over a 5G/NR radio access network (RAN)), or by accessing the 5GC through a 4G radio access (i.e., via a 4G/LTE RAN). FIG. 1 illustrates a first situation in which UEs are accessing respective network slices of a 5GC via a 5G NR RAN. Here, UE #1 is connected through a NR RAN to NW slice #1 of the 5GC. AMF #1 and SMF/PGW-C #1 control access to the NW slice #1 for UE #1. The UPF/PGW-U provides the user plane path to the data network DN #1. Similarly, UE #2 accesses NW slice #2 of the 5GC over the NR RAN under the control of AMF #2 and SMF/PGW-C #2, and the user plane path to DN #2 is through the UPF/PGW-U #2.

### FIG. 2

An alternative situation is illustrated in FIG. 2, in which UE #1 and UE #2 may only have access to NW Slice #1 and NW Slice #2 through a 4G/LTE RAN. As shown, the MME in the EPC communicates with SMF/PGW-C of the appropriate network slice each UE is accessing in the 5G network. Thus, the MME cooperates with the 5G network to manage access to the respective 5G network slices. The user plane path in the EPC is through the SGW-U.

To initiate UE access to a network slice of the 5GC via 4G radio access, as illustrated in FIG. 2, a Mobility Management Entity (MME) selects an SMF/PGW-C, for example, by means of Domain Name System (DNS) procedures (TS 23.401 ch. 4.3.8.1; TS 29.303 ch. 5.12.3), and the selected SMF/PGW-C selects a UPF/PGW-U (TS 23.214 ch. 4.3.3; 5.12; TS 23.501 ch. 6.3.3).

The following tables shows some key parameters for a combined SMF/PGW-C in its Network Function (NF) profile stored in the NF Repository Function (NRF), where the SMF is configured to support an array of network slices (Network Slice Selection Assistance Information (NSSAI)), and each network slice is configured with a number of supported Data Network Names (i.e. Access Point Names (APNs) for 4G/3G/2G network). Note that the NSSAI is a collection of S-NSSAIs. An S-NSSAI identifies a network slice.

TABLE 6.1.6.2.12-1
Definition of type SmfInfo

| Attribute name | Data type | P | Cardinality | Description |
|---|---|---|---|---|
| sNssaiSmfInfoList | array(sNssaiSmfInfoItem) | M | 1 . . . N | List of parameters supported by the SMF per S- |
| | | | | NSSAI (NOTE 1). |
| taiList | array(Tai) | O | 1 . . . N | The list of TAIs the SMF can serve. It may contain |
| | | | | the non-3GPP access TAI. The absence of this |
| | | | | attribute and the taiRangeList attribute indicate that |
| | | | | the SMF can be selected for any TAI in the serving |
| | | | | network. |
| taiRangeList | array(TaiRange) | O | 1 . . . N | The range of TAIs the SMF can serve. It may contain |
| | | | | the non-3GPP access' TAI. The absence of this |
| | | | | attribute and the taiList attribute indicate that the |
| | | | | SMF can be selected for any TAI in the serving |
| | | | | network. |
| pgwFqdn | Fqdn | O | 0 . . . 1 | The FQDN of the PGW if the SMF is a combined |
| | | | | SMF/PGW-C. |
| accessType | array(AccessType) | C | 1 . . . 2 | If included, this IE shall contain the access type |
| | | | | (3GPP_ACCESS and/or NON_3GPP_ACCESS) |
| | | | | supported by the SMF. |
| | | | | If not included, it shall be assumed the both access |
| | | | | types are supported. |
| priority | integer | O | 0 . . . 1 | Priority (relative to other NFs of the same type) in the |
| | | | | range of 0-65535, to be used for NF selection for a |
| | | | | service request matching the attributes of the |
| | | | | SmfInfo; lower values indicate a higher priority. |
| | | | | See the precedence rules in the description of the |
| | | | | priority attribute in NFProfile, if Priority is also |
| | | | | present in the nfServiceList parameters or in |
| | | | | NFProfile. |
| | | | | The NRF may overwrite the received priority value |
| | | | | when exposing an NFProfile with the |
| | | | | Nnrf_NFDiscovery service. |
| | | | | (NOTE 2) |

(NOTE 1):
If this S-NSSAIs is present in the SmfInfo and in the NFprofile, the S-NSSAIs from the SmfInfo shall prevail.
(NOTE 2):
An SMF profile may e.g. contain multiple SmfInfo entries, with each entry containing a different list of TAIs and a different priority, to differentiate the priority to select the SMF based on the user location. The priority in SmfInfo has the least precedence, i.e. it applies between SMFs or SMF Services with the same priority.

TABLE 6.1.6.2.29-1
Definition of type SnssaiSmfInfoItem

| Attribute name | Data type | P | Cardinality | Description |
|---|---|---|---|---|
| sNssai | Snssai | M | 1 | Supported S-NSSAI |
| dnnSmfInfoList | array(DnnSmfInfoItem) | M | 1 . . . N | List of parameters supported by the SMF per |
| | | | | DNN |

During an Evolved Packet System (EPS) to 5G System (5GS) mobility procedure (i.e., EPC to 5GC), the PGW Node Name is transferred from the Source MME to the target AMF when an N26 interface is available, or the target AMF receives the PGW Node Name from the Unified Data Management (UDM)/Home Subscriber Server (HSS) when an N26 interface is not available.

As an example, in TS 23.502, 4.11.1.2.2, step 4 (for the case in which N26 is available):
4. The initial AMF invokes the Nsmf_PDUSession_CreateSMContext service operation (UE EPS PDN Connection, initial AMF ID, data Forwarding information, Target ID) on the SMF identified by the PGW-C+SMF address and indicates handover (HO) preparation indication (to avoid switching the UP path).

As another example, in TS 23.502, 4.11.2.3 EPS to 5GS Mobility, step 9:
The AMF determines the S5/S8 interface of the PGW-C+SMF for the PDU Session based on the DNN received from the UE and the PGW-C+SMF ID in the subscription profile received from the HSS+UDM in step 5, or when the HSS+UDM notifies the AMF for the new PGW-C+SMF ID in the updated subscription profile. The AMF queries the NRF in the serving PLMN by issuing the Nnrf_NFDiscovery_Request including the FQDN for the S5/S8 interface of the PGW-C+SMF, and the NRF provides the IP address or FQDN of the N11/N16 interface of the PGW-C+SMF. The AMF invokes the Nsmf_PDUSession_CreateSMContext service with the SMF address provided by the NRF. The AMF includes the PDU Session ID to the request sent to the PGW-C+SMF.

This is also reflected in stage 3 specification e.g. in TS 29.274, the Forward Relocation Request message is used for connected mode mobility procedure.

TABLE 7.3.1-2
MME/SGSN/AMF UE EPS PDN Connections within Forward Relocation Request

| | |
|---|---|
| Octet 1 | PDN Connection IE Type = 109 (decimal) |
| Octets 2 and 3 | Length = n |
| Octet 4 | Spare and Instance fields |

| Information elements | P | Condition/Comment | IE Type | Ins. |
|---|---|---|---|---|
| APN | M | | APN | 0 |
| APN Restriction | C | This IE denotes the restriction on the combination of types | APN Restriction | 0 |
| | | of APN for the APN associated with this EPS bearer | | |
| | | Context. The target MME or SGSN determines the | | |
| | | Maximum APN Restriction using the APN Restriction. | | |
| | | If available, the source MME/S4SGSN shall include this IE. | | |
| Selection Mode | CO | When available, this IE shall be included by the source | Selection Mode | 0 |
| | | MME/S4-SGSN/AMF. | | |
| IPv4 Address | C | This IE shall not be included if no IPv4 Address is | IP Address | 0 |
| | | assigned. See (NOTE 1). | | |
| IPv6 Address | C | This IE shall not be included if no IPv6 Address is | IP Address | 1 |
| | | assigned. | | |
| Linked EPS Bearer ID | M | This IE identifies the default bearer of the PDN | EBI | 0 |
| | | Connection. | | |
| PGW S5/S8 IP | M | This IE shall include the TEID in the GTP based S5/S8 | F-TEID | 0 |
| Address for Control | | case and the uplink GRE key in the PMIP based S5/S8 | | |
| Plane or PMIP | | case. | | |
| | | See NOTE 4. | | |
| PGW node name | C | This IE shall be included if the source MME, SGSN or AMF | FQDN | 0 |
| | | has the PGW FQDN. | | |
| | CO | This IE shall be included by the source MME over the | | |
| | | N26 interface. See NOTE 6. | | |

NOTE 6:
The PGW Node Name is used by the target AMF in the NF Service Discovery procedure to find the combined PGW-C/SMF for the PDU Session during an MME to AMF mobility procedure.

And the Context Response message is used for Idle mode mobility procedure.

TABLE 7.3.6-2
MME/SGSN/AMF UE EPS PDN Connections within Context Response

| | |
|---|---|
| Octet 1 | PDN Connection IE Type = 109 (decimal) |
| Octets 2 and 3 | Length = n |
| Octet 4 | Spare and Instance fields |

| Information elements | P | Condition/Comment | IE Type | Ins. |
|---|---|---|---|---|
| APN | M | | APN | 0 |
| APN Restriction | C | This IE denotes the restriction on the combination of types | APN Restriction | 0 |
| | | of APN for the APN associated with this EPS bearer | | |
| | | Context. The target MME or SGSN determines the | | |
| | | Maximum APN Restriction using the APN Restriction. | | |
| | | If available, the source MME/S4 SGSN shall include this | | |
| | | IE. | | |
| Selection Mode | CO | When available, this IE shall be included by the source | Selection Mode | 0 |
| | | MME/S4-SGSN/AMF. | | |
| IPv4 Address | C | This IE shall not be included if no IPv4 Address is | IP Address | 0 |
| | | assigned. See (NOTE 1). See NOTE 5. | | |
| IPv6 Address | C | This IE shall not be included if no IPv6 Address is | IP Address | 1 |
| | | assigned. See NOTE 5. | | |
| Linked EPS Bearer ID | M | This IE identifies the default bearer of the PDN | EBI | 0 |
| | | Connection. | | |
| PGW S5/S8 IP | M | This IE shall include the TEID in the GTP based S5/S8 | F-TEID | 0 |
| Address for Control | | case and the uplink GRE key in the PMIP based S5/S8 | | |
| Plane or PMIP | | case. | | |
| | | See NOTE 3. | | |
| PGW node name | C | This IE shall be included if the source MME, SGSN or AMF | FQDN | 0 |
| | | has the PGW FQDN. | | |
| | CO | This IE shall be included by the source MME over the N26 | | |
| | | interface. See NOTE 6. | | |

NOTE 6:
The PGW Node Name is used by the target AMF in the NF Service Discovery procedure to find the combined PGW-C/SMF for the PDU Session during an MME to AMF mobility procedure

### SUMMARY

There currently exist certain challenge(s). In general, the MME does not have sufficient information (i.e. no network slice information, which is part of 5G subscription information) to select an SMF/PGW-C supporting the correct network slice.

The key parameter used by the MME to select a PGW is the Access Point Name (APN), which may be used across a number of network slices, i.e. multiple network slices may support access to the same Data network (identified by the APN). However, the PGW may be configured to support only a subset of network slices for a given APN, and the UE may have a subscription only allowing access to specific network slices for that APN. In other words, the APN may be used across a number of network slices, where only some of those network slices may be supported by the selected PGW, and the UE may have a subscription to a network slice that is not supported by the selected PGW.

In short, the PGW selected by the MME may not be able to accept a request for creation of a session for the PDN connection if the PGW is not configured to support the network slice that the UE subscription allows among the network slices for the requested APN.

The standard does not specify any requirement when the above scenario takes place. One approach is certainly to reject the request, however such rejection results in a very bad Key Performance Indicator (KPI) and, when the UE tries again to establish the PDN connection, the request may be rejected again.

Certain aspects of the present disclosure and their embodiments may provide solutions to the aforementioned or other challenges.

There are, proposed herein, various embodiments which address one or more of the issues disclosed herein.

In some embodiments, a method for interworking between a 4G EPC and a 5G EPC in a network node is disclosed. In some embodiments, a method of operation of a first network node (e.g., a first SMF/PGW-C) comprises receiving a request to create a session for a UE for a particular APN/DNN and determining that the first network node is not configured to support a subscribed network slice of the UE that contains the particular APN/DNN. In some embodiments, the method further comprises identifying a second network node (e.g., PGW2 or second SMF/PGW-C) that is configured to support the subscribed network slice of the UE that contains the particular APN/DNN and transferring the request to create a session for the UE for the particular APN/DNN.

In some embodiments, a method of operation of a first network node (e.g., a first SMF/PGW-C) comprises receiving a request to create a session for a UE for a particular APN/DNN and determining that the first network node is not configured to support a subscribed network slice of the UE that contains the particular APN/DNN. In some embodiments, the method further comprises identifying a second network node (e.g., PGW2 or second SMF/PGW-C) that is configured to support the subscribed network slice of the UE that contains the particular APN/DNN, and sending a response to the request, the response comprising information that indicates the second network node.

In some embodiments, a method of operation of a first network node comprises sending to a second network node (e.g., SMF/PGW-C #1), a request to create a session for a UE for a particular APN/DNN, and receiving, from a third network node (e.g., SMF/PGW-C #2), a response to the request.

In some embodiments, a method includes a first network node sending, to a second network node (e.g., SMF/PGW-C #1), a request to create a session for a UE for a particular APN/DNN, receiving, from the second network node, a response to the request, the response comprising information that indicates a third network node (e.g., SMF/PGW-C #2), and sending the request to the third network node.

In some embodiments, method includes a second network node receiving, from a first network node (e.g., SMF/PGW-C #2), a request to create a session for a UE for a particular APN/DNN, the request comprising information that enables or otherwise causes the second network node to send the response to an originating node of the request wherein the originating node is a node from which the first network node received the request, and sending, to the originating node, a response to the request.

Certain embodiments may provide one or more of the following technical advantage(s). The proposed solution significantly increases the probability that session continuity can be maintained within the correct Network Slice when the UE first attaches to E-UTRAN and then moves into 5G access.

### BRIEF DESCRIPTION OF THE DRAWINGS

The accompanying drawings, which are included to provide a further understanding of the disclosure and are incorporated in a constitute a part of this application, illustrate certain non-limiting embodiments of inventive concepts. In the drawings:

FIG. 1 illustrates a first situation in which UEs are accessing respective network slices of a 5GC via a 5G NR RAN;

FIG. 2 illustrates an alternative situation in which UE #1 and UE #2 may only have access to NW Slice #1 and NW Slice #2 through a 4G/LTE RAN;

FIG. 3 illustrates an example alternative wherein a SMF/PGW-C redirects a Create Session Request message;

FIG. 4 illustrates an example alternative wherein an alternative SMF/PGW-C #2 is provided in a Create Session Response message;

FIG. 5 illustrates a schematic example alternative wherein a SMF/PGW-C #1 redirects a Create Session Request to a SMF/PGW-C #1;

FIG. 6 illustrates one example of a cellular communications system in which embodiments of the present disclosure may be implemented;

FIG. 7 is a schematic block diagram of a core network node according to some embodiments of the present disclosure;

FIG. 8 is schematic block diagram that illustrates a virtualized embodiment of the core network node according to some embodiments of the present disclosure;

FIG. 9 is a schematic block diagram of the core network node according to some other embodiments of the present disclosure.

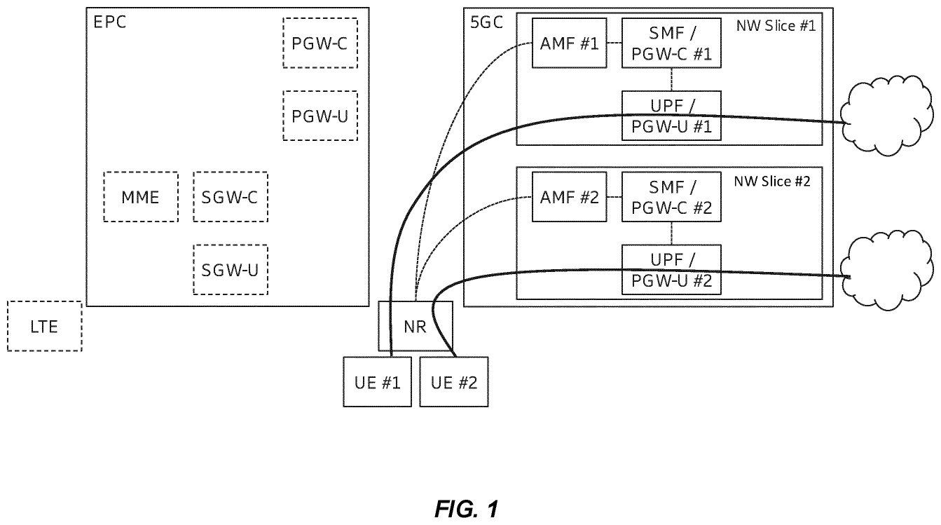

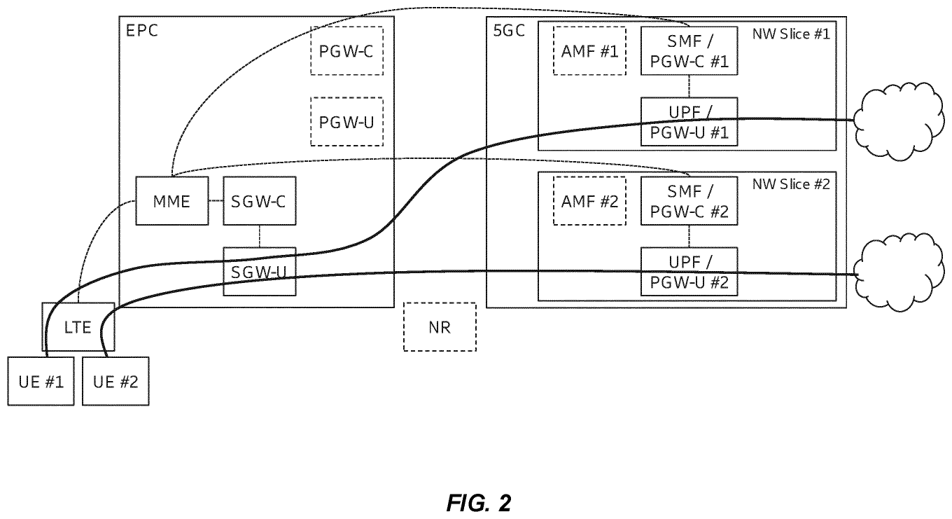

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may also be found in the document(s) provided in the Appendix.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a UPF, a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

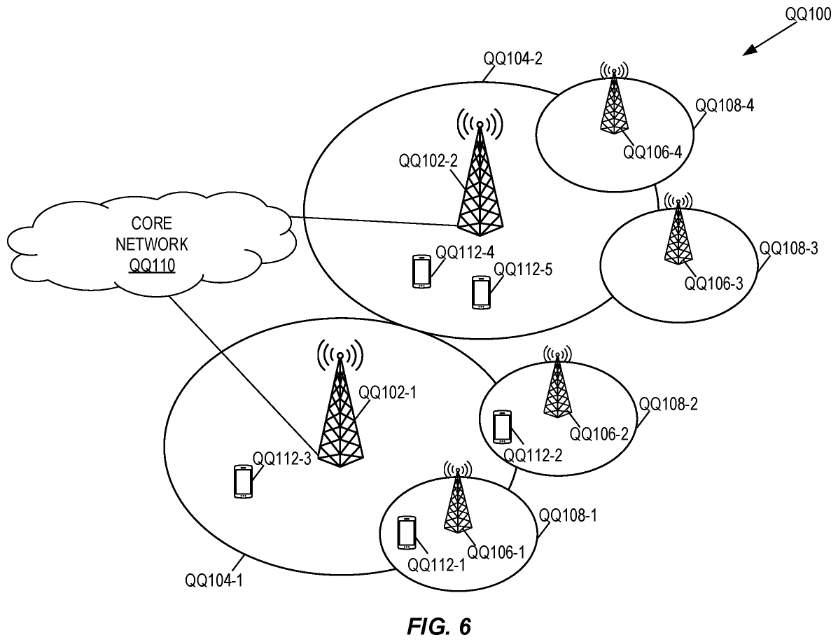

FIG. 6

FIG. 6 illustrates one example of a cellular communications system QQ100 in which embodiments of the present disclosure may be implemented. In the embodiments described herein, the cellular communications system QQ100 is a combination of a 5G system (5GS) including a NR RAN and a 5GC and a 4G system (i.e. an EPS) including an LTE RAN and an EPC. In this example, the RAN includes base stations QQ102-1 and QQ102-2, which in LTE are referred to as eNBs (when connected to EPC) and in 5G NR are referred to as gNBs (e.g., LTE RAN nodes connected to 5GC, which are referred to as ng-eNBs), controlling corresponding (macro) cells QQ104-1 and QQ104-2. The base stations QQ102-1 and QQ102-2 are generally referred to herein collectively as base stations QQ102 and individually as base station QQ102. Likewise, the (macro) cells QQ104-1 and QQ104-2 are generally referred to herein collectively as (macro) cells QQ104 and individually as (macro) cell QQ104. The RAN may also include a number of low power nodes QQ106-1 through QQ106-4 controlling corresponding small cells QQ108-1 through QQ108-4. The low power nodes QQ106-1 through QQ106-4 can be small base stations (such as pico or femto base stations) or Remote Radio Heads (RRHs), or the like. Notably, while not illustrated, one or more of the small cells QQ108-1 through QQ108-4 may alternatively be provided by the base stations QQ102. The low power nodes QQ106-1 through QQ106-4 are generally referred to herein collectively as low power nodes QQ106 and individually as low power node QQ106. Likewise, the small cells QQ108-1 through QQ108-4 are generally referred to herein collectively as small cells QQ108 and individually as small cell QQ108. The cellular communications system QQ100 also includes a core network(s) QQ110. For example, in the embodiments described herein, the core network(s) QQ110 include a 5GC and an EPC, wherein there is interworking between the 5GC and EPC. The base stations QQ102 (and optionally the low power nodes QQ106) are connected to the core network(s) QQ110.

The base stations QQ102 and the low power nodes QQ106 provide service to wireless communication devices QQ112-1 through QQ112-5 in the corresponding cells QQ104 and QQ108. The wireless communication devices QQ112-1 through QQ112-5 are generally referred to herein collectively as wireless communication devices QQ112 and individually as wireless communication device QQ112. In the following description, the wireless communication devices QQ112 are oftentimes UEs, but the present disclosure is not limited thereto.

For interworking between EPC (4G) and 5GC, when an SMF/PGW-C is selected by the MME and the PGW-C/SMF receives the Create Session Request, the SMF/PGW-C will retrieve Session Management Subscription data from the UDM as specified in 5.2.2.2.5 Session Management Subscription Data Retrieval. Among other things, the Create Session Request includes information that indicates the requested APN/DNN, and the subscription data of the UE includes the subscribed S-NSSAI that contains the requested APN/DNN (information that indicates the subscribed network slice that contains the requested APN/DNN). Using this information, the SMF/PGW-C determines whether it is configured to support the subscribed S-NSSAI that contains the requested APN/DNN. In other words, the SMF/PGW-C determines whether it is able to (or configured to) support the subscribed network slice that uses the requested APN/DNN. If the SMF/PGW-C determines that it is not configured to support the subscribed S-NSSAI which contains the requested APN/DNN, the SMF/PGW-C signals to the NRF to perform a service discovery procedure, to find a SMF/PGW-C that does support a session on the UE subscribed S-NSSAI that contains the particular APN/DNN.

After that, there are two alternative approaches, each of which are described below in detail. In general, in the first alternative (Alternative 1), the SMF/PGW-C redirects the Create Session Request message to the SMF/PGW-C, found via the NRF discovery procedure, that does support the subscribed S-NSSAI and the requested APN. In the second alternative (Alternative 2), the SMF/PGW-C sends a Create Session Response message that includes information that indicates the new SMF/PGW-C that does support the subscribed S-NSSAI and the requested APN.

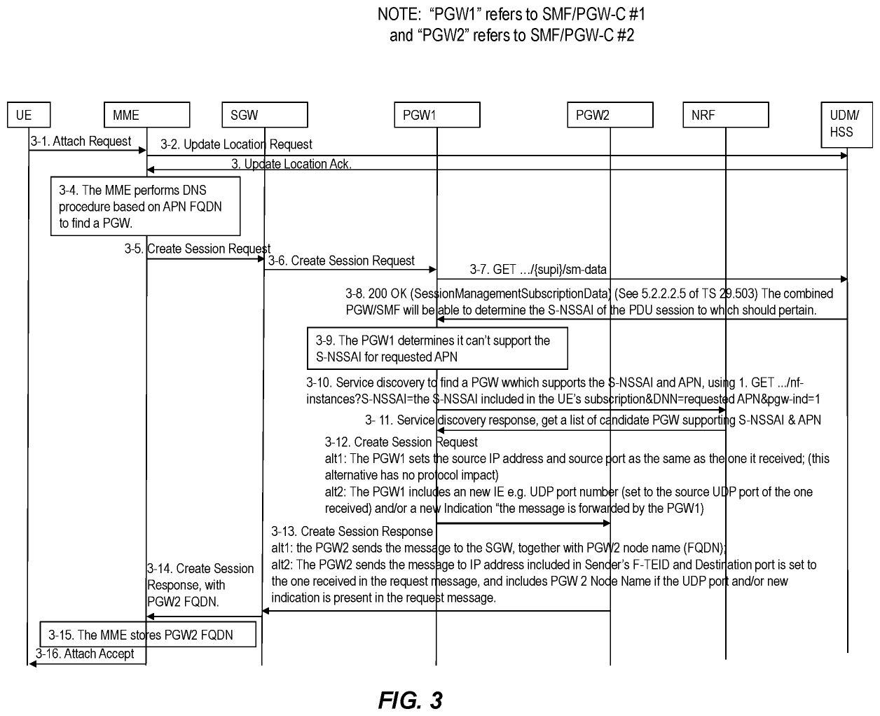

### FIG. 3

### Alternative 1: Redirecting Create Session Request Message

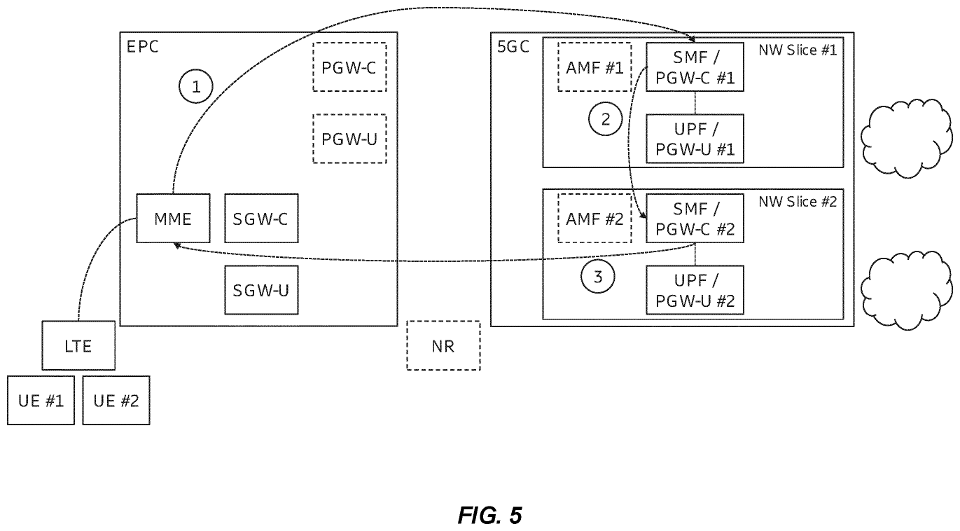

In this alternative, after the MME selected SMF/PGW-C receives the information from the NRF, the SMF/PGW-C redirects the Create Session Request message to the new SMF/PGW-C. One example procedure that illustrates this alternative is illustrated in FIG. 3. The steps of the procedure of FIG. 3 are as follows:
Step 1: The UE sends an attach request to the MME in the EPC.
Step 2: The MME sends an Update Location Request message to the UDM/HSS.
Step 3: The UDM/HSS returns an Update Location Acknowledgement message back to the MME.
Step 4: The MME selects a PGW. More specifically, the MME performs a DNS procedure based on the requested APN FQDN (from the attach request) to find a PGW. In this example, the selected PGW is more specifically a SMF/PGW-C #1 (i.e., a network function with combined PGW-C and SMF capability).
Steps 5 and 6: The MME sends a Create Session Request message to SMF/PGW-C #1 via the SGW. In steps 5 and 6 of FIG. 3, the MME that originates the Create Session Request message sends it to the SGW, which forwards it to the selected PGW (SMF/PGW-C #1). Also, see e.g. step 1 in FIG. 5.
Steps 7 and 8: SMF/PGW-C #1 retrieves Session Management Subscription data from the UDM as specified in 5.2.2.2.5 Session Management Subscription Data Retrieval. Among other things, the Create Session Request includes information that indicates the requested APN/DNN, and the subscription data of the UE includes the subscribed S-NSSAI that contains the requested APN/DNN (information that indicates the subscribed network slice that contains the requested APN/DNN).
Step 9: Using this information, SMF/PGW-C #1 determines whether it is configured to support the subscribed S-NSSAI that contains the requested APN/DNN. In other words, the SMF/PGW-C #1 determines whether it is able to (configured to) support the subscribed network slice that uses the requested APN/DNN. In this example, SMF/PGW-C #1 determines that that it is not configured to support the subscribed S-NSSAI which contains the requested APN/DNN.
Steps 10 and 11: Upon determining that it is not configured to support the subscribed S-NSSAI which contains the requested APN/DNN, SMF/PGW-C #1 signals to the NRF to perform a service discovery procedure to find a PGW that does support the subscribed S-NSSAI and the requested APN. In this example, the newly found PGW that does supported the subscribed S-NSSAI and the requested APN is denoted as SMF/PGW-C #2.
Step 12: SMF/PGW-C #1 redirects the Create Session Request message to PGW2. In one aspect shown in step 12 of FIG. 3, when the SMF/PGW-C #1 (selected by the MME) redirects the Create Session Request message to the new PGW (SMF/PGW-C #2), SMF/PGW-C #1 may operate according to one of the following sub-alternatives (also, see e.g. step 2 in FIG. 5):
   sub-alt 1: SMF/PGW-C #1 sets the source IP address and source port of the Create Session Request message to be the same as those received by SMF/PGW-C #2 (in step 6);
   sub-alt 2: SMF/PGW-C #1 includes a new Information Element (IE) in the Create Session Request message sent to SMF/PGW-C #2 (e.g. UDP port number set to the source UDP port of the one received in step 6 and/or a new Indication that the Create Session Request message has been transferred by the SMF/PGW-C #1).
Steps 13 and 14: New SMF/PGW-C #2 sends a Create Session Response message to the SGW, which forward the Crease Session Response message to the MME. Also, see e.g. step 3 in FIG. 5. When the new SMF/PGW-C #2 sends the Create Session Response (CS Response) message in step 13, it may operate as follows according to the above alternatives:
   sub-alt 1: SMF/PGW-C #2 sends the Create Session Response message to the SGW, together with a new IE containing the SMF/PGW-C #2 node name (FQDN). This information may be sent if the SMF/PGW-C #2 is a combined PGW-C/SMF.
   sub-alt 2: SMF/PGW-C #2 sends the Create Session Response message to the IP address included in the Sender's F-TEID and the Destination port is set to the one received in the CSR message. The Create Session Response message includes the SMF/PGW-C #2 Node Name if the UDP port and/or new indication is present in the CS Request message.
Step 15: The MME stores the SMF/PGW-C #2 FQDN.
Step 16: The MME sends an Attach Accept message to the UE.

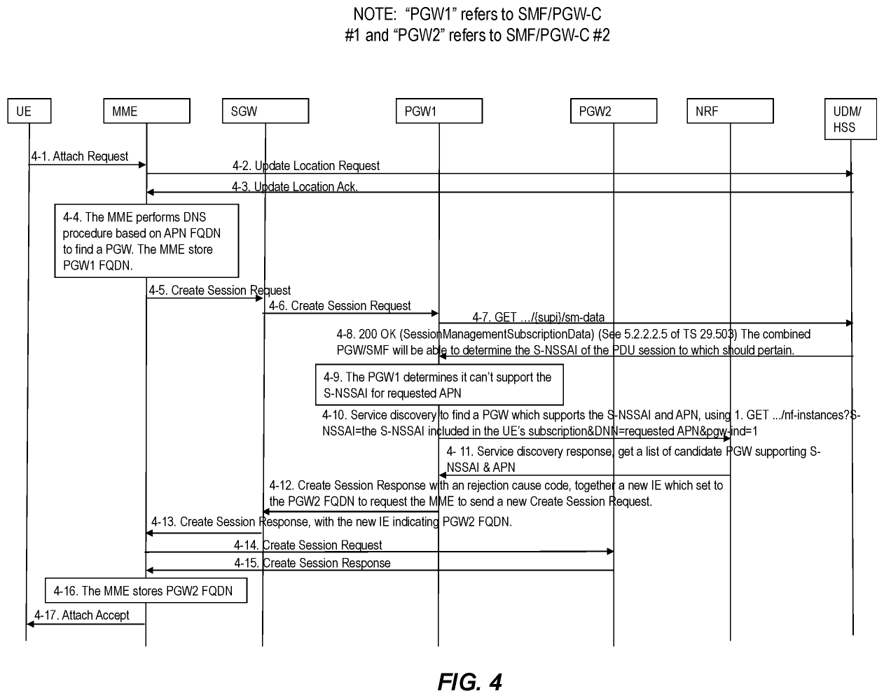

### FIG. 4

### Alternative 2: Providing Alternative SMF/PGW-C #2 in Create Session Response Message

In another aspect, after the SMF/PGW-C signals to the NRF to perform a service discovery procedure to find a SMF/PGW-C that does support the subscribed S-NSSAI and the APN for the PDN connection, a second alternative can be used in which information that indicates SMF/PGW-C #2 is returned in the Create Session Response message.

FIG. 4 illustrates one example of a procedure that utilizes Alternative 2. The steps of the procedure of FIG. 4 are as follows:
Steps 1-11: Same as Steps 1-11 of FIG. 3.
Step 12: The MME selected SMF/PGW-C #1 rejects the Create Session Request message, and in the Create Session Response message includes a new IE, e.g. which may be set to the PGW Node Name (FQDN) and SMF/PGW-C #2IP address, and a new cause code value, preferably called “redirect to another PGW”.
Step 13: The SGW forwards the Create Session Response message to the MME.
Step 14: The MME sends a new Create Session Request to the SMF/PGW-C #2 indicated by the SMF/PGW-C #2IP address, where, in this example, the PDN connection creation is successful.
Step 15: PGW returns a Create Session Response message to the MME.
Step 16: The MME stores the SMF/PGW-C #2FQDN.
Step 17: The MME sends an Attach Accept message to the UE.

Note that, in Alternative 2, the new SMF/PGW-C(SMF/PGW-C #2) includes its Fully Qualified Domain Name (FQDN) in the Create Session Response, and this information is utilized by the MME. Note that:
1. The PGW FQDN is used by the AMF if UE moves to 5G, to find the same combined SMF/PGW-C node which is serving this PDN connection, if the CS Request has been redirected (transferred), it shall inform the MME to update the PGW FQDN associated with the PDN connection.
2. In case UE will establish a subsequent PDN Connection to the same APN/DNN, the same PGW shall be selected.

The problem being addressed and aspects of the disclosed solution(s) can be summarized as follows:
SMF/PGW-C #1 and SMF/PGW-C #2 both support the same APN/DNN but in different Network Slices.
MME does not have sufficient information to select an SMF/PGW-C within the correct network slice.
MME selects SMF/PGW-C #1.
MME sends Create Session Request via SGW-C to SMF/PGW-C #1.
SMF/PGW-C #1 finds correct SMF/PGW-C #2.
SMF/PGW-C #1 redirects Create Session Request to SMF/PGW-C #2.
SMF/PGW-C #1 will need to manipulate the IP header.
SMF/PGW-C #2 replies via SGW-C to MME. In the reply message SMF/PGW-C #2 includes its Fully Qualified Domain Name (FQDN). The FQDN information element is not defined for the Create Session Response message (TS 29.274 ch. 7.2.2). It needs to be defined. Alternatively, the same information can be included in a Private Extension information element in the same message.

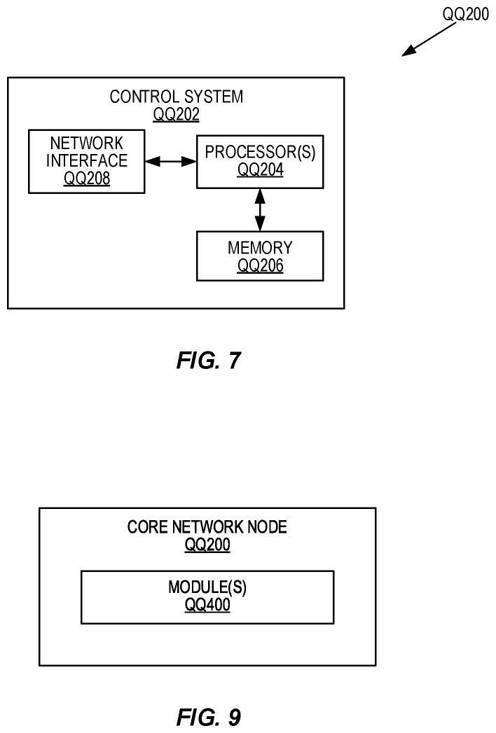

### FIG. 7

FIG. 7 is a schematic block diagram of a core network node QQ200 according to some embodiments of the present disclosure. The core network node QQ200 may be, e.g., a network node that implements an EPC node such as a MME, SGW, PGW, PGW-C, or the like, a 5GC NF such as a SMF, NRF, UDM/HSS, or the like, or a combined network function such as, e.g., an SMF/PGW-C. Optional features are represented by dashed boxes. As illustrated, the core network node QQ200 includes a control system QQ202 that includes one or more processors QQ204 (e.g., Central Processing Units (CPUs), Application Specific Integrated Circuits (ASICs), Field Programmable Gate Arrays (FPGAs), and/or the like), memory QQ206, and a network interface QQ208. The one or more processors QQ204 are also referred to herein as processing circuitry. In one embodiment, the processors QQ204 execute software (e.g., stored in memory QQ206) to perform the functions of an EPC node, a 5GC NF, or a combined network function (e.g., SMF/PGG-C) according to any of the embodiments described herein.

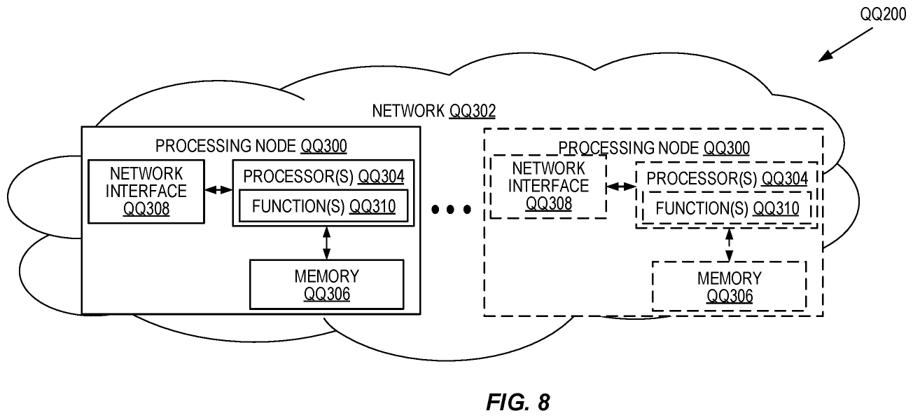

### FIG. 8

FIG. 8 is a schematic block diagram that illustrates a virtualized embodiment of the core network node QQ200 according to some embodiments of the present disclosure. This discussion is equally applicable to other types of network nodes. Further, other types of network nodes may have similar virtualized architectures. Again, optional features are represented by dashed boxes.

As used herein, a “virtualized” core network node is an implementation of the core network node QQ200 in which at least a portion of the functionality of the core network node QQ200 is implemented as a virtual component(s) (e.g., via a virtual machine(s) executing on a physical processing node(s) in a network(s)). The core network node QQ200 includes one or more processing nodes QQ300 each coupled to or included as part of a network(s) QQ302. If present, the control system QQ202 is connected to the processing node(s) QQ300 via the network QQ302. Each processing node QQ300 includes one or more processors QQ304 (e.g., CPUs, ASICs, FPGAs, and/or the like), memory QQ306, and a network interface QQ308.

In this example, functions QQ310 of the core network node QQ200 described herein (e.g., functions of a an EPC node, a 5GC NF, or a combined network function (e.g., SMF/PGG-C) according to any of the embodiments described herein, e.g., with respect to FIG. 3 or 4) are implemented at the one or more processing nodes QQ300 or distributed across two or more processing nodes QQ300 in any desired manner. In some particular embodiments, some or all of the functions QQ310 of the core network node QQ200 described herein are implemented as virtual components executed by one or more virtual machines implemented in a virtual environment(s) hosted by the processing node(s) QQ300.

In some embodiments, a computer program including instructions which, when executed by at least one processor, causes the at least one processor to carry out the functionality of a core network node QQ200 or a node (e.g., a processing node QQ300) implementing one or more of the functions QQ310 of the core network node QQ200 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

### FIG. 9

FIG. 9 is a schematic block diagram of the core network node QQ200 according to some other embodiments of the present disclosure. The core network node QQ200 includes one or more modules QQ400, each of which is implemented in software. The module(s) QQ400 provide the functionality of the core network node QQ200 described herein (e.g., functions of an EPC node, a 5GC NF, or a combined network function (e.g., SMF/PGG-C) according to any of the embodiments described herein, e.g., with respect to FIG. 3 or 4). This discussion is equally applicable to the processing node QQ300 of FIG. 8 where the modules QQ400 may be implemented at one of the processing nodes QQ300 or distributed across multiple processing nodes QQ300 and/or distributed across the processing node(s) QQ300 and the control system QQ202.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Embodiments

Some of the embodiments are described above can be summarized in the following manner:

1. A method performed by a first network node (e.g., SMF/PGW-C #1) for interworking between a 4G Evolved Packet Network (EPC) and a 5G core (5GC), the method comprising:
receiving (FIG. 3, step 6), at a first network node, a request to create a session for a UE for a particular APN/DNN;
determining (FIG. 3, step 9) that the first network node is not configured to support a subscribed network slice of the UE that contains the particular APN/DNN;
identifying (FIG. 3, step 11) a second network node (e.g., PGW2 or second SMF/PGW-C) that is configured to support the subscribed network slice of the UE that contains the particular APN/DNN; and
transferring (FIG. 3, step 12), to the second network node, the request to create a session for the UE for the particular APN/DNN.
   2. The method of embodiment 1, wherein:
the transferred request comprises an indication that the request is transferred from the first network node.
   3. The method of embodiment 1 or 2, wherein:
the first network node is a first packet data network gateway (PGW) node; and
the second network node is a second PGW node.
   4. The method of embodiment 1 or 2, wherein:
the first network node is a first combined SMF/PGW-C; and
the second network node is a second combined SMF/PGW-C.
   5. A method performed by a network node for interworking between a 4G Evolved Packet Network (EPC) and a 5G Core, the method comprising:
receiving (FIG. 4, step 6), at a first network node, a request to create a session for a UE for a particular APN/DNN;
determining (FIG. 4, step 9) the first network node is not configured to support a subscribed network slice of the UE that contains the particular APN/DNN;
identifying (FIG. 4, step 11) a second network node (e.g., PGW2 or second SMF/PGW-C) that is configured to support the subscribed network slice of the UE that contains the particular APN/DNN; and
sending (FIG. 4, step 12) a response to the request, the response comprising information that indicates the second network node.
   6. The method of embodiment 5, wherein:
the information that indicates the second network node comprised in the response comprises a fully qualified domain name (FQDN) of the second network node.
   7. The method of embodiment 5 or 6, wherein:
the first network node is a first packet data network gateway (PGW) node; and
the second network node is a second PGW node.
   8. The method of embodiment 5 or 6, wherein:
the first network node is a first combined SMF/PGW-C; and
the second network node is a second combined SMF/PGW-C.
   9. A method performed by a first network node (e.g., MME) for interworking between a 4G Evolved Packet Network (EPC) and a 5G Core, the method comprising:
sending (FIG. 3, step 5), to a second network node (e.g., SMF/PGW-C #1), a request to create a session for a UE for a particular APN/DNN; and
receiving (FIG. 3, step 14), from a third network node (e.g., PGW2 or second SMF/PGW-C), a response to the request.
   10. The method of embodiment 9, wherein:
the response received from the third network node comprises a fully qualified domain name (FQDN) of the third network node.
   11. The method of embodiment 9 or 10, wherein:
the first network node is a MME.
   12. The method of embodiment 9 or 10, wherein:
the first network node is a first packet data network gateway (PGW) node; and
the second network node is a second PGW node.
   13. The method of embodiment 9 or 10, wherein:
the first network node is a first combined SMF/PGW-C; and
the second network node is a second combined SMF/PGW-C.
   14. A method performed by a network node (e.g., MME) for interworking between a 4G Evolved Packet Network (EPC) and a 5G Core, the method comprising:
sending (FIG. 4, step 5 or 6), to a second network node (e.g., SMF/PGW-C #1), a request to create a session for a UE for a particular APN/DNN;
receiving (FIG. 4, step 12 or 13), from the second network node, a response to the request, the response comprising information that indicates a third network node (e.g., PGW2 or second SMF/PGW-C); and
sending (FIG. 4, step 14) the request to the third network node.
   15. The method of embodiment 14, wherein:
the response received from the second network node comprises a fully qualified domain name (FQDN) of the third network node.
   16. The method of embodiment 14 or 15, wherein:
the first network node is a MME.
   17. The method of embodiment 14 or 15, wherein:
the first network node is a first packet data network gateway (PGW) node; and
the second network node is a second PGW node.
   18. The method of embodiment 14 or 15, wherein:
the first network node is a first combined SMF/PGW-C; and
the second network node is a second combined SMF/PGW-C.
   19. A method performed by a second network node (e.g., PGW2 or second SMF/PGW-C) for interworking between a 4G Evolved Packet Network (EPC) and a 5G Core, the method comprising:
receiving (FIG. 3, step 12), at the second network node from a first network node (SMF/PGW-C #2), a request to create a session for a UE for a particular APN/DNN, the request comprising information that enables or otherwise causes the second network node to send the response to an originating node of the request wherein the originating node is a node from which the first network node received the request; and
sending (FIG. 3, step 13), to the originating node, a response to the request.
   20. The method of embodiment 19, wherein:
the response comprises a fully qualified domain name (FQDN) of the second network node.
   21. The method of embodiment 19 or 20, wherein:
the first network node is a first packet data network gateway (PGW) node; and
the second network node is a second PGW.
   22. The method of embodiment 19 or 20, wherein:
the first network node is a first combined SMF/PGW-C; and
the second network node is a second combined SMF/PGW-C.
   23. The method of any one of embodiments 19 to 22, wherein:
the originating node is a MME or serving gateway (SGW) node.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
2G Second Generation
3G Third Generation
3GPP Third Generation Partnership Project
4G Fourth Generation
5G Fifth Generation
AF Application Function
AMF Access and Mobility Management Function
AN Access Network
AP Access Point
AUSF Authentication Server Function
BS Base Station
BSC Base Station Controller
BTS Base Transceiver Station
CDMA Code Division Multiple Access
DL Downlink
DN Data Network
DNS Domain Name System
eNB Enhanced or Evolved Node B
EPC Evolved Packet Core
E-UTRA Evolved Universal Terrestrial Radio Access
E-UTRAN Evolved Universal Terrestrial Radio Access Network
FDD Frequency Division Duplexing
FQDN Fully Qualified Domain Name
GERAN Global System for Mobile (GSM) Communications Enhanced Data Rates for GSM Evolution Radio Access Network
gNB New Radio Base Station
GSM Global System for Mobile Communications
HO Handover
HSPA High Speed Packet Access
IoT Internet of Things
IP Internet Protocol
LAN Local Area Network
LTE Long Term Evolution
M2M Machine-to-Machine
MME Mobility Management Entity
MSC Mobile Switching Center
MTC Machine Type Communication
NEF Network Exposure Function
NF Network Function
NFV Network Function Virtualization
NR New Radio
NRF Network Function Repository Function
NSSF Network Slice Selection Function
O&M Operation and Maintenance
OSS Operations Support System
OTT Over-the-Top
PCF Policy Control Function
PDN Public Data Network, or Packet Data Network
PGW Packet Data Network Gateway
PGW-C PGW Control Plane Function
PGW-U PGW User Plane Function
PLMN Public Land Mobile Network
PSTN Public Switched Telephone Networks
QoS Quality of Service
RAN Radio Access Network
RAT Radio Access Technology
RNC Radio Network Controller
SCEF Service Capability Exposure Function
SGW Serving Gateway
SGW-C SGW Control Plane Function
SGW-U SGW User Plane Function
SI System Information
SIB System Information Block
SIM Subscriber Identity Module
SMF Session Management Function
TCP Transmission Control Protocol
UDM Unified Data Management
UE User Equipment
UL Uplink
UMTS Universal Mobile Telecommunications System
UPF User Plane Function
USIM Universal Subscriber Identity Module
UTRA Universal Terrestrial Radio Access
UTRAN Universal Terrestrial Radio Access Network
VNE Virtual Network Element
VNF Virtual Network Function
WAN Wide Area Network
WCDMA Wideband Code Division Multiple Access
WD Wireless Device
WLAN Wireless Local Area Network

1. A method performed by a first network node (SMF/PGW-C #1) for interworking between a 4G Evolved Packet Network (EPC) and a 5G core (5GC), the method comprising:
receiving, at a first network node, a request to create a session for a User Equipment (UE) for a particular Access Point Name/Data Network Name (APN/DNN);
determining that the first network node is not configured to support a subscribed network slice of the UE that contains the particular APN/DNN;
identifying a second network node (PGW2, SMF/PGW-C #2) that is configured to support the subscribed network slice of the UE that contains the particular APN/DNN; and
transferring, to the second network node, the request to create a session for the UE for the particular APN/DNN.

2. The method of claim 1, wherein:
the transferred request comprises an indication that the request is transferred from the first network node.

3. The method of claim 1, wherein:
the first network node is a first packet data network gateway (PGW) node; and
the second network node is a second PGW node.

4. The method of claim 1, wherein:
the first network node is a first combined SMF/PGW-C; and
the second network node is a second combined SMF/PGW-C.

5. A method performed by a network node for interworking between a 4G Evolved Packet Network (EPC) and a 5G Core, the method comprising:
receiving, at a first network node, a request to create a session for a User Equipment (UE) for a particular Access Point Name/Data Network Name (APN/DNN);
determining the first network node is not configured to support a subscribed network slice of the UE that contains the particular APN/DNN;
identifying a second network node (PGW2, SMF/PGW-C #2) that is configured to support the subscribed network slice of the UE that contains the particular APN/DNN; and
sending a response to the request, the response comprising information that indicates the second network node.

6. The method of claim 5, wherein:
the information that indicates the second network node comprised in the response comprises a fully qualified domain name (FQDN) of the second network node.

7. The method of claim 5, wherein:
the first network node is a first packet data network gateway (PGW) node; and
the second network node is a second PGW node.

8. The method of claim 5, wherein:
the first network node is a first combined SMF/PGW-C; and
the second network node is a second combined SMF/PGW-C.

9. A method performed by a first network node (MME) for interworking between a 4G Evolved Packet Network (EPC) and a 5G Core, the method comprising:
sending, to a second network node (SMF/PGW-C #1), a request to create a session for a User Equipment (UE) for a particular Access Point Name/Data Network Name (APN/DNN); and
receiving, from a third network node (PGW2, SMF/PGW-C #2), a response to the request.

10. The method of claim 9, wherein:
the response received from the third network node comprises a fully qualified domain name (FQDN) of the third network node.

11. The method of claim 9, wherein:
the first network node is a MME.

12. The method of claim 9, wherein:
the first network node is a first packet data network gateway (PGW) node; and
the second network node is a second PGW node.

13. The method of claim 9, wherein:
the first network node is a first combined SMF/PGW-C; and
the second network node is a second combined SMF/PGW-C.

14. A method performed by a network node (MME) for interworking between a 4G Evolved Packet Network (EPC) and a 5G Core, the method comprising:
sending, to a second network node (SMF/PGW-C #1), a request to create a session for a User Equipment (UE) for a particular Access Point Name/Data Network Name (APN/DNN);
receiving, from the second network node, a response to the request, the response comprising information that indicates a third network node (PGW2, SMF/PGW-C #2); and
sending the request to the third network node.

15. The method of claim 14, wherein:
the response received from the second network node comprises a fully qualified domain name (FQDN) of the third network node.

16. The method of claim 14, wherein:
the first network node is a MME.

17. The method of claim 14, wherein:
the first network node is a first packet data network gateway (PGW) node; and
the second network node is a second PGW node.

18. The method of claim 14, wherein:
the first network node is a first combined SMF/PGW-C; and
the second network node is a second combined SMF/PGW-C.

19. A method performed by a second network node (PGW2, SMF/PGW-C #2) for interworking between a 4G Evolved Packet Network (EPC) and a 5G Core, the method comprising:
receiving, at the second network node from a first network node (SMF/PGW-C #2), a request to create a session for a User Equipment (UE) for a particular Access Point Name/Data Network Name (APN/DNN), the request comprising information that enables or otherwise causes the second network node to send the response to an originating node of the request wherein the originating node is a node from which the first network node received the request; and
sending, to the originating node, a response to the request.

20. The method of claim 19, wherein:
the response comprises a fully qualified domain name (FQDN) of the second network node.

21. The method of claim 19, wherein:
the first network node is a first packet data network gateway (PGW) node; and
the second network node is a second PGW.

22. The method of claim 19, wherein:
the first network node is a first combined SMF/PGW-C; and
the second network node is a second combined SMF/PGW-C.

23. The method of claim 19, wherein:
the originating node is a MME or serving gateway (SGW) node.
